(19) United States
(12) Patent Application Publication
(10) Pub. No.: US 2013/0021233 A1
(43) Pub. Date: Jan. 24, 2013

(54) APPARATUS, SYSTEM, AND METHOD FOR PROVIDING FEEDBACK SENSATIONS OF TEMPERATURE AND HARDNESS-SOFTNESS TO A CONTROLLER

(71) Applicants: Frederick Umminger, Oakland, CA (US); Jeffrey R. Stafford, Redwood City, CA (US); Anton Mikhailov, Campbell, CA (US)

(72) Inventors: Frederick Umminger, Oakland, CA (US); Jeffrey R. Stafford, Redwood City, CA (US); Anton Mikhailov, Campbell, CA (US)

(21) Appl. No.: 13/188,360

(22) Filed: Jul. 21, 2011

(51) Int. Cl. G09G 5/00

(52) U.S. Cl. 345/156

(57) ABSTRACT

Described herein are hand-held controller, system, and method for providing real-time sensations of temperature and/or hardness-softness to the hand-held controller. The hand-held controller comprises a first region configured to be touched by a user and to provide a real-time computer programmable hardness-softness sensation to the user in response to a first trigger signal generated by an interactive program; and a first mechanism, coupled to the first region, to cause the first region to harden relative to a first state, and to cause the first region to soften relative to a second state.

### FIELD OF THE INVENTION

Embodiments of the invention relate generally to the field of computerized sensations. More particularly, embodiments of the invention relate to an apparatus, system, and method for providing real-time sensations of temperature and hardness-softness to a handheld controller.

### BACKGROUND

As audio visual devices such as gaming platforms, smart phones, tablets, televisions, etc., provide a higher level of interactive experience to a user of such audio visual devices, there is demand for providing more real-time sensations to a user of such audio visual devices.

The term “interactive experience” herein refers to an experience in which a user interacts with a program (software, television broadcast, etc.) executing on an audio/visual device (e.g., computer or television screen) and provides real-time information to the program of the audio/visual device, and in response to providing such information the user receives information back from the executing program.

An example of known real-time sensations is the vibration of a gaming controller. Vibrations may be generated when, for example, the user of the gaming controller encounters an undesired event associated with an audio-visual game while playing the game—car driven by a user when the car slides off a road causing a vibration of the remote controller held by the user. However, such real-time sensations provided to a user are not rich enough (i.e., lacks triggering multiple human sensations) to immerse the user into the interactive experience.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1A illustrates a generic interactive system with a handheld controller configured to provide sensations of temperature and hardness-softness to a user, according to one embodiment of the invention.

FIG. 1B illustrates a snapshot of an executing program, on an audio-visual device, with surrounding context to provide a user controlling a character in that context, the sensations of temperature and hardness-softness in view of that context, according to one embodiment of the invention.

FIG. 2 illustrates a handheld controller having regions which are configured to provide temperature and hardness-softness sensations, according to one embodiment of the invention.

FIG. 3 illustrates a cross-section of a region of the handheld controller which is configured to provide hardness-softness sensations to a user via the handheld controller, according to one embodiment of the invention.

FIG. 4 illustrates a cross-section of a region of the handheld controller which is configured to provide hardness-softness sensations to a user via the handheld controller, according to another embodiment of the invention.

FIG. 5A illustrates a cross-section of a region of the handheld controller which is configured to provide hardness-softness sensations to a user via the handheld controller, according to one embodiment of the invention.

FIG. 5B illustrates a cross-section of a region of the handheld controller which is configured to provide temperature sensations to a user via the handheld controller, according to one embodiment of the invention.

FIG. 6 illustrates a cross-section of a region of the handheld controller which is configured to provide hardness-softness sensations to a user via the handheld controller, according to one embodiment of the invention.

FIG. 7 illustrates a user interface to configure settings of temperature and hardness-softness sensations for one or more users, according to one embodiment of the invention.

FIG. 8A is a high level method flowchart for providing hardness-softness sensations to a user, according to one embodiment of the invention.

FIG. 8B is a high level method flowchart for providing temperature sensations to a user, according to one embodiment of the invention.

FIG. 9 is a method flowchart for providing hardness-softness sensations to a user by means of a fabric having interleaved memory metal, according to one embodiment of the invention.

FIG. 10 is a high level interactive system diagram with a processor operable to execute computer readable instructions to cause sensations of temperature and hardness-softness to a user via a handheld controller, according to one embodiment of the invention.

FIG. 11 illustrates hardware of an interactive system with user interfaces which is operable to provide temperature and hardness-softness sensations, according to one embodiment of the invention.

FIG. 12 illustrates additional hardware which is operable to process computer executable instructions to cause the interactive system to provide temperature and hardness-softness sensations, according to one embodiment of the invention.

FIG. 13 illustrates an interactive system with users interacting with one another via the internet and for providing sensations of temperature and hardness-softness, according to one embodiment of the invention.

### SUMMARY

Embodiments of the invention relate generally to the field of computerized sensations. More particularly, embodiments of the invention relate to an apparatus, system, and method for providing real-time sensations of temperature and hardness-softness to a user of a controller.

Described herein is an embodiment of a handheld controller comprising: a first region configured to be touched by a user and to provide a real-time computer programmable hardness-softness sensation to the user in response to a first trigger signal generated by an interactive program; and a first mechanism, coupled to the first region, to cause the first region to harden relative to a first state, and to cause the first region to soften relative to a second state.

Described herein is an embodiment of a system comprising: a processor; an interactive application executing on the processor, the interactive application to generate a first trigger signal representing a context of the executing interactive program; and a hand-held controller comprising: a first region configured to be touched by a user and to provide a real-time computer programmable hardness-softness sensation to the user in response to the first trigger signal generated by the interactive program; and a first mechanism, coupled to the first region, to cause the first region to harden relative to a first state, and to cause the first region to soften relative to a second state.

Described herein is an embodiment of a method comprising: executing an interactive program on a processor; selecting levels of a computer programmable hardness-softness sensation via a user interface associated with the executing interactive program; positioning a controller to a particular context of the interactive program; receiving, by the controller, a first trigger signal in response to the positioning; and in response to receiving the first trigger signal, performing one of: generating a first signal to cause a first region of the controller to harden relative to a first state; and generating a second signal to cause the first region of the controller to soften relative to a second state.

### DETAILED DESCRIPTION

Embodiments of the invention relate generally to the field of computerized sensations. More particularly, embodiments of the invention relate to an apparatus, system, and method for providing real-time sensations of temperature and hardness-softness to a user of a handheld controller. The term “temperature sensation” herein is interchangeably referred to as “thermal sensation.” The term “handheld controller” is also interchangeably referred to as a “controller.”

In one embodiment, an interactive program (i.e., software) is executed on a processor and displayed on an audio-visual device. In one embodiment, the interactive program is configured to generate a trigger signal when a user holding the controller points to a context displayed on the audio-visual device. In one embodiment, the trigger signal is received by the controller held by the user. In one embodiment, the trigger signal causes the controller to generate one or both sensations of temperature and hardness-softness to the user by means of regions on the controller in contact with the user. In one embodiment, the user can adjust the levels of sensations for temperature and/or hardness-softness via a user interface associated with the interactive program.

As used herein, unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In one embodiment, the program is configured to generate a first trigger signal when a user holding the controller points to a first context displayed on the audio-visual device. In one embodiment, the controller comprises a first region configured to be touched by the user and to provide real-time computer programmable hardness-softness sensations to the user in response to receiving the first trigger signal associated with the first context. In one embodiment, the controller comprises a first mechanism, coupled to the first region, to cause the first region to harden relative to a first state, and to cause the first region to soften relative to a second state, wherein the first and second states represent levels of hardness-softness of the first region.

For example, in one embodiment a user holding the controller is a character of an interactive game (also referred to as an interactive program) executing by a processor and displayed by the audio-visual device. When the user points the controller, which in one embodiment is being tracked by a motion detector, towards a first context of the game which represents a hard surface (e.g., the character walking on a concrete surface), the first trigger signal is generated by the executing gaming program that is transmitted to the controller held by the user. The controller then causes the first region of the controller in contact with the user's hand to harden to provide a sensation of hardness to the user.

Referring to the same example, in one embodiment when the character of the user moves to a second context representing a soft surface (e.g., the character walking in a desert with soft sand), the first trigger signal is generated again by the executing gaming program which is transmitted to the user via the controller. The controller then causes the first region of the controller in contact with the user's hand to soften to provide a sensation of softness to the user.

In one embodiment, the controller comprises a second region configured to be touched by the user and to provide real-time computer programmable temperature sensations to the user in response to a second trigger signal generated by the interactive program. In one embodiment, the controller comprises a second mechanism, coupled to the second region, to cause the second region to heat up relative to a third state and to cause the second region to cool down relative to a fourth state, wherein the first and the second regions reside on an outer surface of the controller, and wherein the third and fourth states represent thermals levels of sensations provided by the second region.

For example, in one embodiment when the user points the controller towards a third context of the game which represents a hot surface or surrounding environment (e.g., the character is walking on a concrete surface in hot summer day), the second trigger signal is generated again by the executing gaming program that is transmitted to the controller held by the user. The controller then causes the second region of the controller in contact with the user's hand to heat up to provide a sensation of high temperature (hot concrete surface) to the user. In this embodiment, in response to the controller receiving first and second trigger signals, the controller provides both sensations of hardness and high temperature representing hot concrete.

Referring to the same example, in one embodiment when the character of the user moves to a fourth context representing a soft surface (e.g., the character walking in a desert with soft sand at night), the second trigger signal is generated again by the executing gaming program which is transmitted to the controller of the user. The controller then causes the second region of the controller in contact with the user's hand to cool down to provide a sensation of coolness to the user. In this embodiment, the controller provides both sensations of softness and cool temperature representing desert sand at night in response to the controller receiving first and second trigger signals.

The term “real-time” herein refers to providing sensations of temperature and hardness-softness to a user holding the hand-held controller such that the user perceives the sensations (within a few milliseconds) when the first and/or second trigger signals are generated by the interactive program and received by the hand-held controller.

In the following description, numerous details are discussed to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Note that in the corresponding drawings of the embodiments signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme, e. g., differential pair, single-ended, etc.

In the embodiments discussed herein, the hardness-softness sensations are referred to in terms of Shore's hardness scale and/or Young's modulus. In the embodiments discussed herein, the temperature sensations are referred to in terms of levels of degrees in Fahrenheit.

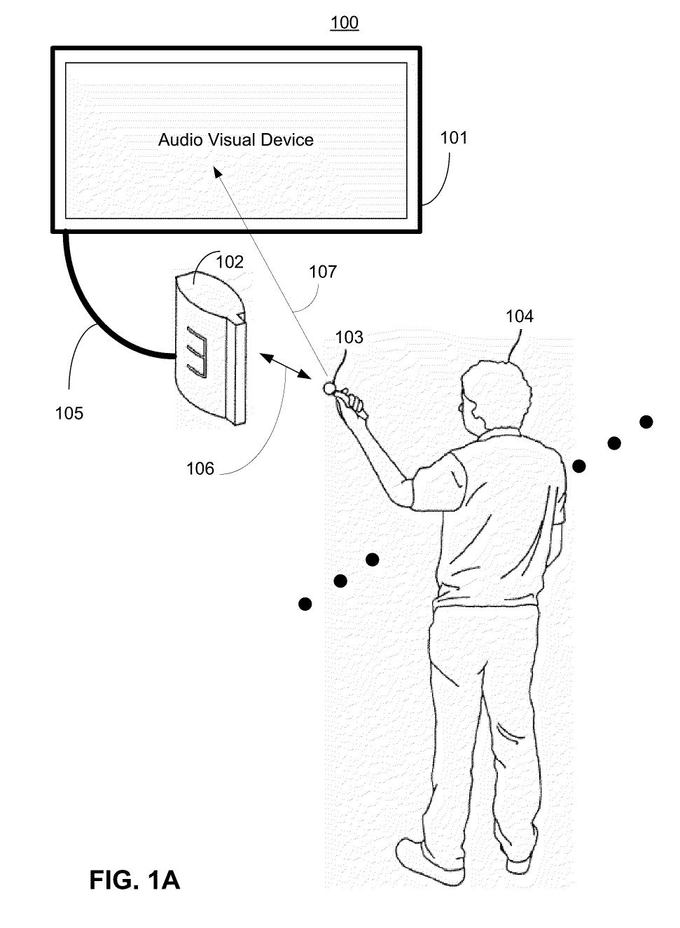

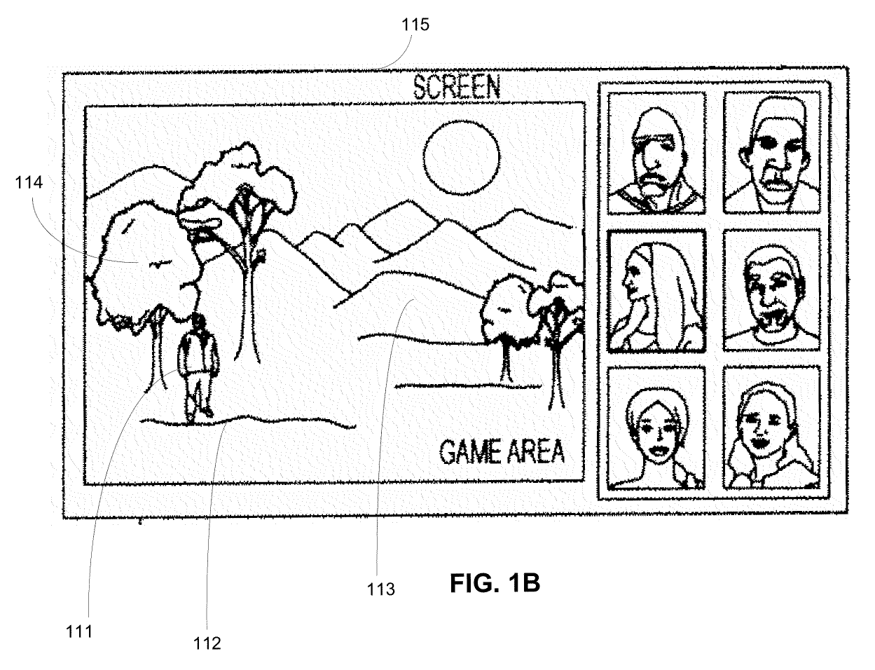

FIG. 1A illustrates a generic interactive system 100 with a controller 103 configured to provide sensations of temperature and hardness-softness to a user, according to one embodiment of the invention. In one embodiment, the system 100 comprises a computer system 102 communicatively coupled to an audio-visual device 101 by means of an electric wire 105. In other embodiment, the computer system 102 is communicatively coupled to the audio-visual device 101 by wireless means (not shown). In one embodiment, the computer system 102 includes a general purpose computer, a special purpose computer, a gaming console, or other such device which executes an interactive program that is rendered on the audio-visual device 101.

Examples of gaming consoles include those manufactured by Sony Computer Entertainment, Inc. and other manufacturers. In one embodiment, the audio-visual device 101 is a television, a monitor, a projector display, or other such displays and display systems which are capable of receiving and rendering video output from the computer system 102. In one embodiment, the audio-visual device 101 is a flat panel display which displays various contexts to a user. These contexts provide feedback to the controller 103 to generate real-time temperature and hardness-softness sensations to the user.

In one embodiment, a user 104 provides input to the interactive program by operating the controller 103. The term “operating” herein refers to moving the controller, pressing buttons on the controller, etc. In one embodiment, the controller 103 communicates wirelessly 106 with the computer system 102 for greater freedom of movement of the controller 103 than a wired connection. In one embodiment, the controller 103 includes any of various features for providing input to the interactive program, such as buttons, a joystick, directional pad, trigger, touchpad, touch screen, or other types of input mechanisms. One example of a controller is the Sony Dualshock 3® controller manufactured by Sony Computer Entertainment, Inc.

In one embodiment, the controller 103 is a motion controller that enables the user 104 to interface with and provide input to the interactive program by moving the controller 103. One example of a motion controller is the Playstation Move® controller, manufactured by Sony Computer Entertainment, Inc. Various technologies may be employed to detect the position and movement of a motion controller. For example, a motion controller may include various types of motion detection hardware, such as accelerometers, gyroscopes, and magnetometers. In some embodiments, a motion controller can include one or more cameras to capture images of a fixed reference object. The position and movement of the motion controller can then be determined through analysis of the images captured by the one or more cameras. In some embodiments, a motion controller may include an illuminated element which is tracked via a camera having a fixed position. In one embodiment, the tracked motion 107 of the controller 103 causes the generation of the first and second trigger signals that further cause generation of temperature and hardness-softness sensations to the user 104 of the controller 103.

FIG. 1B illustrates a snapshot 115 of an executing program to provide first and second trigger signals to the controller 103 of FIG. 1A, according to one embodiment of the invention. In one embodiment, the first and second trigger signals generate sensations of hardness-softness and temperature, according to one embodiment of the invention. The snapshot 115 comprises a character 111 and its corresponding surrounding contexts 112-114. The character 111 represents the user 104 holding the controller 103 of FIG. 1A.

While the embodiments of the invention describe two trigger signals to provide two different sensations on the controller, the two different sensations may also be generated by a single trigger signal that informs the controller of what type of sensation to generate. In one embodiment, the controller receives the single trigger signal and informs which mechanism(s) (first or second) to generate a corresponding sensation.

In one embodiment, the user 104 positions the controller 103 towards the character 111 of the executing program. As the character 111 moves away from a shaded tree 114 along the rough path 112 towards the hill 113 under the sun, the user 104 holding the controller 103 will experience several different sensations. In this example, the character 111 near the tree experiences shade which results in cool temperature around the character 111.

When the character 111 is positioned near the tree 114, that represents a cool shaded area, the interactive program generates the second trigger signal. In one embodiment, the second trigger signal causes a second mechanism of the controller 103 to cool the portion of the controller 103 held by the user 104. In one embodiment, when the character 111 walks on the rough path 112 near the tree 114, the interactive program generates the first trigger signal. In one embodiment, in response to the first trigger signal, a first mechanism of the controller 103 hardens a portion of the controller 103 held by the user 104.

When the character 111 walks on the rough path 112 towards the hill 113, the temperature rises because of the sun the temperature of the area surrounding the character 111 rises. In this example, the surface on which the character 111 walks is a smooth path to the hill 113. In one embodiment, when the character 111 walks away from the rough path 112 near the tree 114 towards the smooth sunny hill 113, first and second trigger signals are generated by the interactive program. In one embodiment, in response to the first and second trigger signals, the first and second mechanisms of the controller 103 cause the controller 103, held by the user 104, to provide sensations of softness (smooth surface of the hill) and high temperature because of heat generated by the sun. The components comprising the first and second mechanisms of the controller 103 are discussed with reference to several embodiments below.

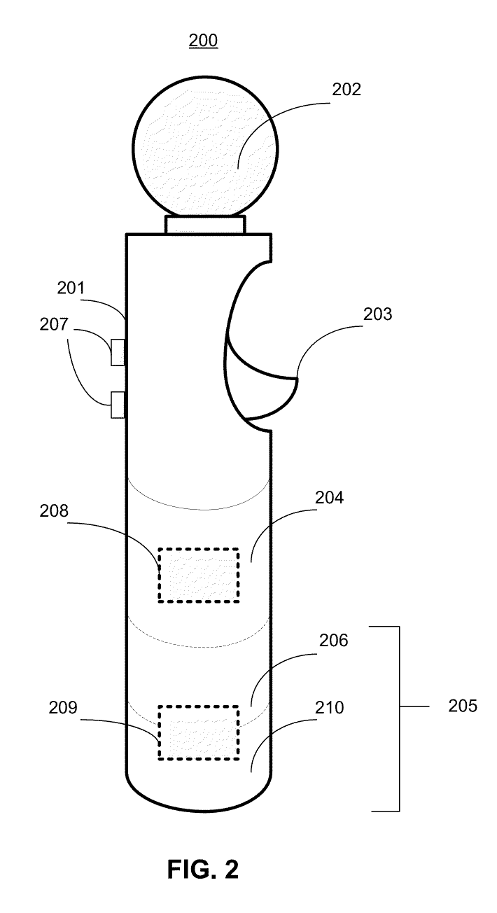

FIG. 2 illustrates a controller 200 (also 103) having regions 204 and 205 which are configured to provide sensations of hardness-softness and temperature, according to one embodiment of the invention. In one embodiment, the controller 200 includes various buttons 207 and a trigger 203 for providing input to an interactive program. In one embodiment, the interactive buttons comprise regions 204 and 205 to provide sensations of hardness-softness and temperature to the user touching the interactive buttons.

In one embodiment, the controller 200 also includes an attachment 202 above the main body 201 of the controller 200. In one embodiment, the attachment 202 is illuminated with various colors in response to trigger signals generated by an interactive program. The controller 200 includes a handle portion for a user to grip, in which various regions 204 and 205 are defined that may be hardened/softened and heated/cooled, respectively. In the embodiments discussed herein, the region 204 is referred to as the first region 204, while the region 205 is referred to as the second region 205. In one embodiment, the first region 204 and the second region 205 are adjacent regions. In one embodiment, the first region 204 and the second region 205 form an outer surface which is configured to be held by a user.

In one embodiment, the controller 200 comprises a first mechanism 208 and a second mechanism 209. In one embodiment, the first mechanism 208 is coupled to the first region 204. In one embodiment, the first mechanism 208 is configured to cause the first region 204 to harden or soften relative to first and second states.

In one embodiment, the first state is a Young's modulus in the range of 2-11 giga-pascals. In one embodiment, the second state is a Young's modulus in the range of 0.01-0.1 giga-pascals. In one embodiment, both the first and second states are predetermined. In one embodiment, both the first and second states are the same. In one embodiment, both the first and second predetermined states are 2 giga-pascals. The higher the value of Young's modulus, the higher the hardness level of the material used to provide sensations of hardness-softness to a user.

In one embodiment, the second mechanism 209 is operable to cause the second region 205 to heat up or cool down relative to third and fourth states. In one embodiment, the third and fourth states are predetermined.

In one embodiment, the third state is 100-120 degrees Fahrenheit. In one embodiment, the fourth state is in the range of 40-50 degrees Fahrenheit. In one embodiment, both the third and fourth states are of the same value. In one embodiment the third and fourth states are 100 degrees Fahrenheit. In one embodiment, the first, second, third, and fourth states are programmable.

In one embodiment, the first region 204 comprises fabric which can be stretched (i.e., pulled taut) to provide a sensation of hardness and can be wrinkled up (i.e., by relaxing the fabric) to provide a sensation of softness. In one embodiment, the fabric includes interleaved memory metal which can cause the fabric to stretch or relax by adjusting the tension levels of the memory metal interleaved within the fabric. In one embodiment, the first region 204 comprises a fabric which is configured to be inflated or deflated to provide the sensations of hardness and softness respectively. In one embodiment, the first region 204 comprises a material which can be hardened or softened in response to cooling and heating the material.

In one embodiment, the second region 205 comprises a metalized fabric that is configured to be heated or cooled down nearly instantaneously. In one embodiment, the second region 205 comprises any fabric which is capable of transmitting heat or cold to a user holding the controller having the fabric. In one embodiment, the second region 205 is divided into two or more regions 206 and 210. In one embodiment, the region 206 of the second region 205 provides a heat sensation to the user holding the controller. In one embodiment, the region 210 of the second region 205 provides a sensation of coolness to the user holding the controller.

While the embodiment of FIG. 2 illustrates two sub regions 206 and 210 of the second region 205, multiple regions configured to be heated and cooled may be arranged in any number of ways. In one embodiment, regions to cool and regions to heat are arranged in an alternating manner adjacent to one another. In one embodiment, the positions of the first and second regions 204 and 205 can be rearranged so that the first region 204 is closer to the end of the controller 200 and below the second region 205.

In one embodiment, the buttons 207 and the trigger 203 comprise first and second regions to provide both sensations of hardness-softness and temperature to the buttons 207 and the trigger 203, respectively. The buttons 207 and the trigger 203 are also referred to herein as interactive buttons. In one embodiment, the first and second mechanisms are insulated from the upper half of the controller 200 to protect any circuitry in the upper half of the controller 200 from noise generated by first and second mechanisms 208 and 209.

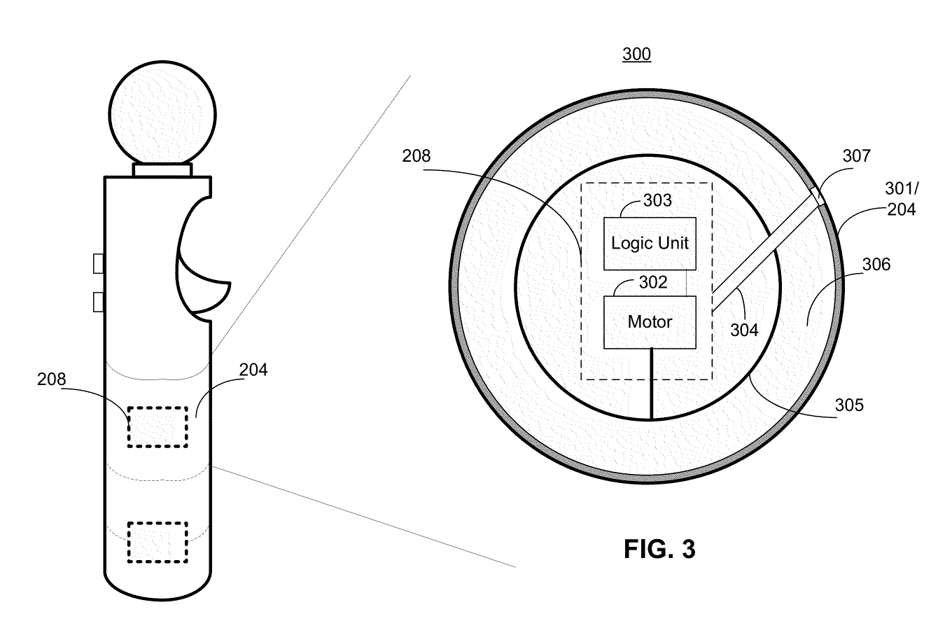

FIG. 3 illustrates a cross-section 300 of the first region 204 of the controller 200 which is configured to provide hardness-softness sensations to a user via the controller 200, according to one embodiment of the invention. In one embodiment, the outer surface of the cross-section 300 is the first region 204/301. In one embodiment, the first region 204/301 comprises a fabric. In one embodiment, the first mechanism 208 is stabilized by a chassis 305 which is configured to hold the first mechanism in a fixed position relative to the first region 204. In one embodiment, the first mechanism 208 comprises a logic unit 303 and an electric motor 302 which is coupled to a push-pull mechanism 304. In one embodiment, the push-pull mechanism 304 is operable to pull the fabric 204 to cause the fabric 204 to harden relative to the first state.

In one embodiment, foam 306 or any comfortable material is placed between the chassis 305 and the first region (fabric) 204/301. One purpose of the foam 306 is to provide a comfortable grip (comprising regions 204/301 and 205 of the controller 200) to a user, and also to provide support to the first region (fabric) 204/301. In one embodiment, the surface of the foam 306 coupling to the fabric 204/301 is smooth enough to allow the fabric 204/301 to be pulled or relaxed without causing any tension on the foam 306 caused by the forces of pull or push.

In one embodiment, the push-pull mechanism 304 comprises a clamp 307 which is operable to pull or relax the fabric 204/301 upon instructions from the logic unit 303 and the electric motor 302. In one embodiment, the electric motor 302 is configured to cause the clamp 307 to pull the fabric thus making the fabric feel hard to a user holding the controller 200. In one embodiment the electric motor 302 causes the clamp 307 to relax the fabric 204/301 thus making the fabric 204/301 feel soft to a user holding the controller 200.

In one embodiment, the push-pull mechanism 304 comprises magnets that cause the fabric 204/301 to be pulled or relaxed when electric current flows through the magnets. In one embodiment, when current flows through the magnets, the magnets attract to one another causing the fabric to be pulled. In one embodiment, when current flows through the magnets, the magnets repel each other causing the fabric to be relaxed. The direction of the current determines whether the magnets will attract to one another or repel one another. In one embodiment, the logic unit 303 is operable to receive the first trigger signal from the interactive program and to determine when to cause the push-pull mechanism 304 to pull or relax the fabric 204/301 in response to the first trigger signal. In one embodiment, the logic unit 303 is programmable to adjust/change the response time of the push-pull mechanism 304.

The term “response time” herein refers to the time it takes the first and/or second mechanisms 208 and 209 to provide sensations of hardness-softness and/or temperature to the first and second regions 204 and 205 respectively.

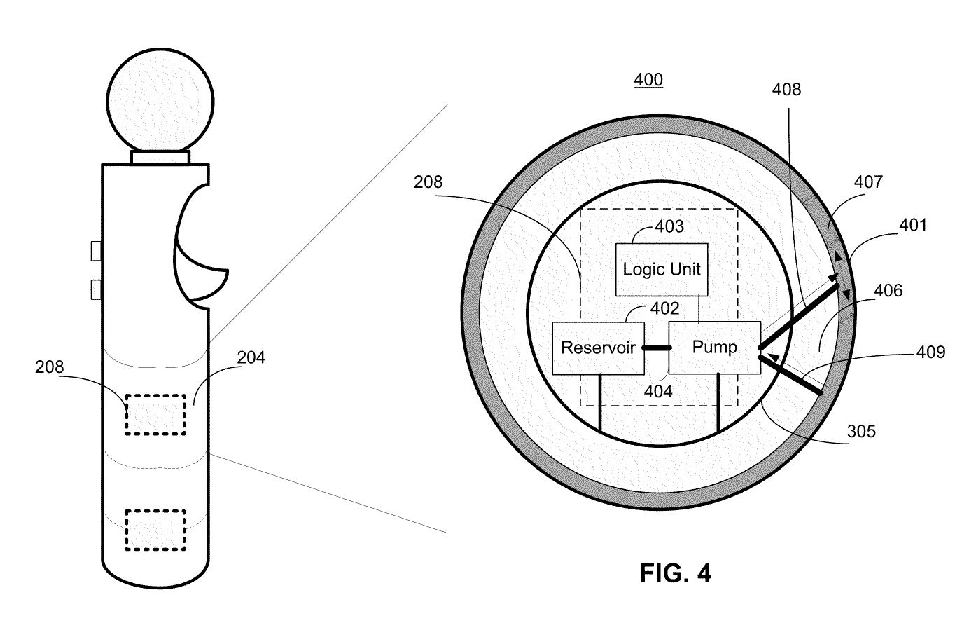

FIG. 4 illustrates a cross-section 400 of the first region 204 of the controller 200 which is configured to provide hardness-softness sensations to a user via the controller 200, according to another embodiment of the invention. In one embodiment, the first mechanism 208 comprises a logic unit 403 coupled to a pump 404 and a reservoir 402. In one embodiment, the reservoir 402 is configured to store an inflating material. In one embodiment, the inflating material is air. In other embodiments, other gasses or liquids may be used as inflating material.

In one embodiment, the first region 204 comprises a fabric 401 which is expandable in response to pressure. In one embodiment, as the fabric 204/401 is expanded (as inflating a balloon) it provides a sensation of hardness to a user holding that fabric 204/401. In one embodiment, as the fabric 204/401 is contracted (as deflating a balloon), the fabric 204/401 provides a sensation of softness to a user holding that fabric 204/401.

In one embodiment, a cavity 407 is formed under the fabric 204/401. In one embodiment, the cavity 407 functions like a balloon. In such an embodiment, the cavity 407 expands when inflating material is pumped into the cavity 407, and deflates when inflating material is sucked out of the cavity 407. In one embodiment, an insulating material 406 or foam is placed between the cavity 407 and the chassis 305. In one embodiment, the insulating material 406 or foam provides support to the cavity 407 so that when the cavity 407 is inflated, it causes the fabric 204/401 to expand away from the controller 200.

In one embodiment, two flexible pipes 408 and 409 are connected between the cavity 407 and the pump 404. In one embodiment, the first pipe 408 is an outgoing pipe that is used to transfer the inflating material out of the pump and to the cavity 407. In one embodiment, the second pipe 409 is an incoming pipe that is used to transfer the inflating material out of the cavity 407 to reservoir 402. In one embodiment, the functions of the first and second pipes 408 and 409 are performed by a single pipe (not shown) which can transfer the inflating material out to the cavity 407 from the reservoir 402, and transfer the inflating material to the reservoir 402 from the cavity 407.

In one embodiment, the pump 404 and the reservoir 402 are held in a stable position relative to the fabric 204/401 by means of the chassis 305. In one embodiment, the pump 404 causes the inflating material to flow to the cavity 407 by pumping out the inflating material through the pipe 408 to the cavity 407. In one embodiment, the pump 404 causes the inflating material to flow from the cavity 407 to the reservoir 402 by sucking the inflating material from the cavity 407 to the reservoir 402.

In one embodiment, the logic unit 403 is operable to receive the first trigger signal and to determine when to cause the pump 404 to pump out or suck in the inflating material in response to the first trigger signal. In one embodiment, the logic unit 403 is configured to be programmed to adjust the response time of the pump 614 i.e., when to pump or suck the inflating material, and also how much to pump or suck the inflating material thus controlling the levels of hardness-softness sensation to a user of the controller 200.

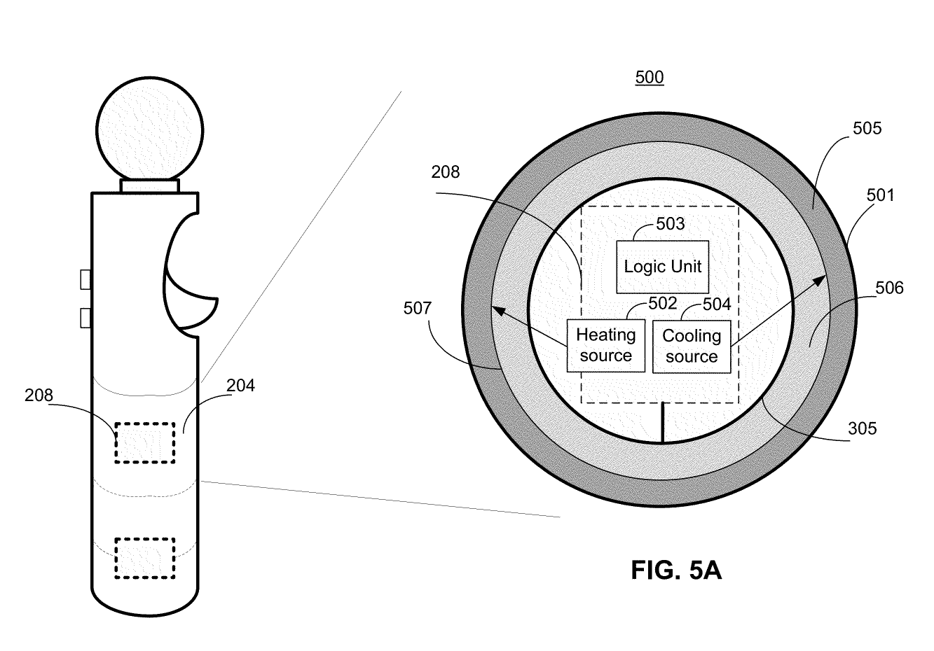

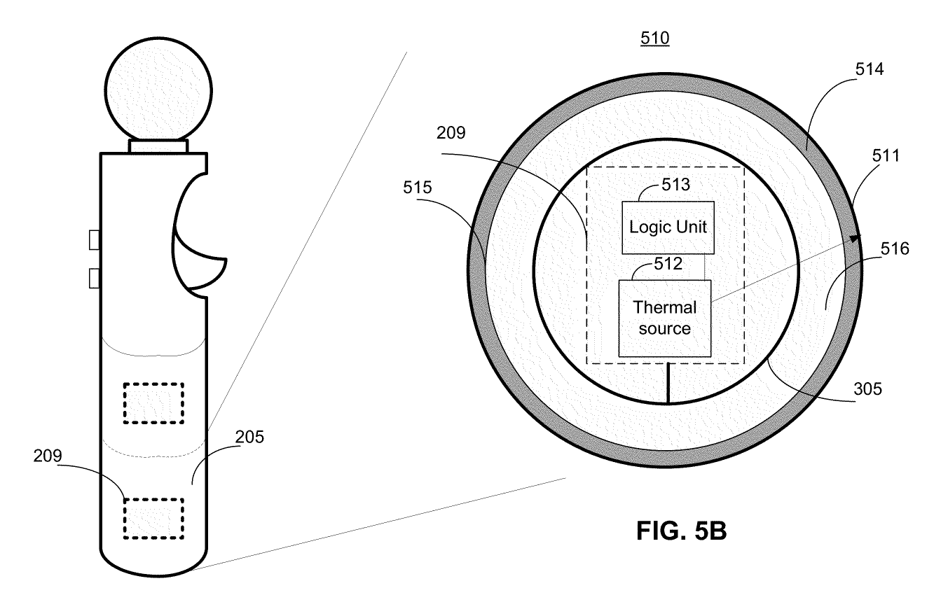

FIG. 5A illustrates a cross-section 500 of the first region 204 of the controller 200 which is configured to provide sensations of hardness-softness to a user via the controller 200, according to one embodiment of the invention. In one embodiment, the first mechanism 208 comprises a logic unit 503 coupled to a heating source 502 and a cooling source 504. In one embodiment, the logic unit 503 is operable to receive the first trigger signal from the interactive program and to determine when to cause the heating and cooling sources 502 and 504 to heat and cool, respectively, the first region 204 in response the first trigger signal.

In one embodiment, the first region 204 comprises a fabric 501 which covers a cavity 505 (like a balloon). In one embodiment, the cavity 505 contains a material which is operable to be hardened or softened in response to a heating signal or a cooling signal respectively. In one embodiment, the material is petroleum jelly. In another embodiment, the material is wax. A person skilled in the art would realize that any material can be used in the embodiment of FIG. 5A which is capable of being hardened or softened in response to electric current or heating/cooling signals.

In one embodiment, the cooling source 504 is operable to transfer a cooling material (refrigerant) from the cooling source 504 and through the cavity 505 containing the material. In one embodiment, the material in the cavity cools down and hardens to provide a cool hard sensation to the user of the controller 200 in response to the transfer of the cooling material. In one embodiment, the size of the cavity 505 is configured so that it contains enough material to be cooled and hardened, and heated and softened, quickly to provide real-time sensations of hardness-softness to a user of the controller 200.

In one embodiment, the heating source 502 is operable to transfer a heating material from the heating source 502 and through the cavity 505 containing the material. In one embodiment, the material in the cavity 505 heats up and softens to provide a hot and soft sensation to the user of the controller 200. In one embodiment, conducting tubing (not shown) in the cavity 505 is used to transfer the heating and cooling materials (refrigerants) through the cavity 505 to cause it to soften and harden respectively. In one embodiment, the cavity 505 is insulated from the first mechanism 208 by means of insulating material 506. In one embodiment, the insulating material 506 is foam.

In one embodiment, the controller 200 also comprises a conducting surface 507 that is operable to be heated or cooled by the heating 502 and cooling 504 sources respectively. In such an embodiment, the function of the conducting tubing is replaced by the conducting surface 507.

FIG. 5B illustrates a cross-section 510 of the second region 205 of the controller 200 which is configured to provide thermal sensations to a user via the controller 200, according to one embodiment of the invention. In one embodiment, the second region 205/511 comprises a fabric or other material which is configured to transfer heat and cold to a user of the controller 200. In one embodiment, the second mechanism 209 comprises a logic unit 513 coupled to the thermal source 512. In one embodiment, the thermal source 512 provides electric current to a thermoelectric device (not shown) located in the region 514.

In one embodiment, the thermoelectric device comprises Peltier cells which are operable to be cooled or heated in response to a potential voltage across the Peltier cells. In one embodiment, the potential voltage across the Peltier cells is generated by the thermal source 512. In one embodiment, a Peltier cell is configured to evolve heat on one side of the cell and to withdraw heat from the opposite side of the cell to cause the opposite side to cool down. In such an embodiment, the same Peltier cell can be used for heating the second region 205/511 and for cooling the same Peltier cell. Another advantage of the Peltier cell is that they comprise no moving parts and are resilient/durable.

In one embodiment, the thermal source 512 is configured to provide enough potential voltage to the Peltier cells to cause the Peltier cells to heat up within a range of 110 degrees Fahrenheit to 125 degrees Fahrenheit, and to cool down the Peltier cells within a range of 50 degrees Fahrenheit to 40 degrees Fahrenheit. In one embodiment, the voltage potential generated by the thermal source 512 is adjustable by a user interface of the interactive program.

In one embodiment, the thermoelectric device (Peltier cells) in the region 514 is insulated by shielding regions 515 and 516. In one embodiment, the shielding region 516 is foam. In one embodiment, the shielding region 515 is made of thick plastic that can withstand temperatures up to 130 degrees Fahrenheit for a continuous period of 5 minutes without deforming. In one embodiment, the logic unit (also referred to as a thermal controller) 513 is operable to determine when to activate the thermal source 512 in response to a second trigger signal from the interactive program.

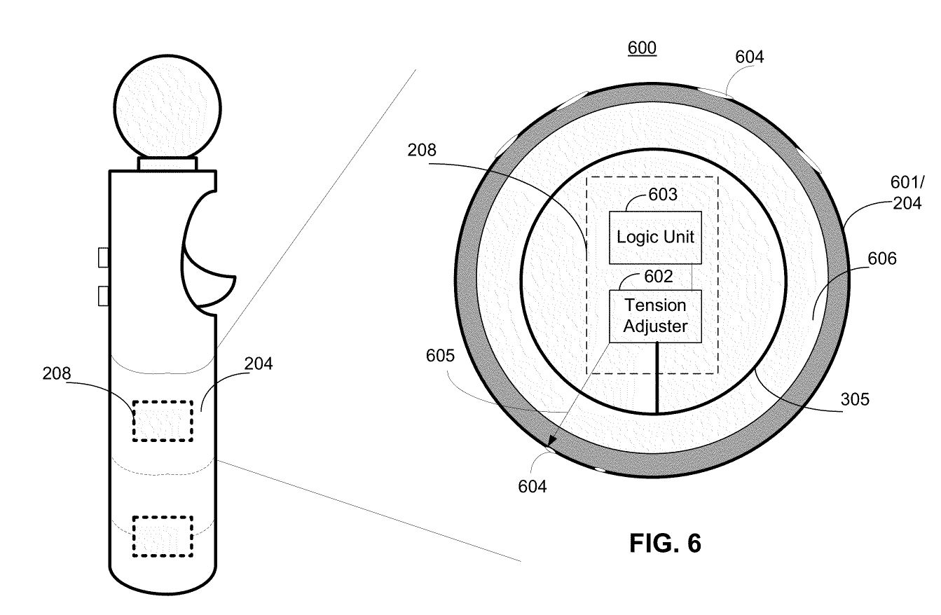

FIG. 6 illustrates a cross-section 600 of the first region 204 of the controller 200 which is configured to provide sensations of hardness-softness to a user 104 via the controller 200, according to another embodiment of the invention. In one embodiment, the first mechanism 208 comprises a logic unit 603 and a tension adjuster 602. In one embodiment, the components of the first mechanism 208 are held stable by means of a chassis 305. In one embodiment, the first region 204 comprises a fabric 601 with memory metal 604 interleaved with the fabric 601.

In one embodiment, the memory metal 604 is configured to receive electric or heating signals that adjust the tension levels of the memory metal 604 to pull or relax the fabric 601. In such an embodiment, the push-pull mechanism 304 (discussed with reference to FIG. 3) having a clamp is not used because the function of the push-pull mechanism is performed by the memory metal 604 itself. In other embodiments, a combination of the push-pull mechanism of FIG. 3 and the interleaved memory metal 604 are used to provide sensations of hardness-softness to a user of the controller 200.

Memory metals 604 are operable to change their tension levels when electric current passes through them. Memory metal is an alloy that remembers its original, cold-forged shape. The memory metal also returns to its pre-deformed shape by heating. The three main types of shape memory alloys are the copper-zinc-aluminum-nickel, copper-aluminum-nickel, and nickel-titanium (NiTi) alloys. Memory metals can also be created by alloying zinc, copper, gold, and iron.

Memory metals are also referred to as Shape Memory Alloys (SMA) which are materials that have the ability to return to a predetermined shape when heated. SMAs behave like electronic muscle which when interleaved with a fabric can cause the fabric to stretched or relaxed in response to current flowing through the SMA. In one embodiment, a 100 micron diameter SMA wire produces 150 g of force in response to 180 mA current flowing through the SMA causing the fabric interleaved with the SMA wire to provide sensations of hardness/softness via the fabric.

In one embodiment, the tension adjuster 602 is operable to generate the electric/heating signals 605 to adjust the tension levels of the memory metal 604. A person skilled in the art would realize that independent wires or wireless signals may be used to transmit the electric/heating signals to the memory metal 604 without changing the essence of the invention. The tension adjuster 602 herein is also referred to as the electronic signal generator 602 because it generates electric/heating signals for adjusting the tension levels of the memory metal 604.

In one embodiment, the electronic signal generator 602 is operable to generate electric current (signal 605) to adjust the tension levels of the memory metal 604 to cause the memory metal 604, interleaved within the fabric 204/601 to pull the fabric 204/601 (i.e., stretch the fabric taut) causing the fabric 204/601 to harden relative to the first state. In one embodiment, the electronic signal generator 602 is operable to generate electric current (signal 605) adjust the tension level of memory metal 604 to cause the memory metal 604 to relax the fabric 204/601 causing the fabric to soften relative to the second state. In one embodiment, the electronic signal generator 602 is operable to generate an electric/heating signal 605 to adjust the tension level of the memory metal 604 to cause the memory metal 604 to enter its default state of tension.

In one embodiment, the first region 204/601 is insulated from the first mechanism 208 by means of insulating material 606. In one embodiment, the insulating material 606 is foam. In one embodiment, the logic unit 603 is configured to determine when to cause the electronic signal generator 602 to generate the first, second, and fifth signals in response to the first trigger signal from the interactive program.

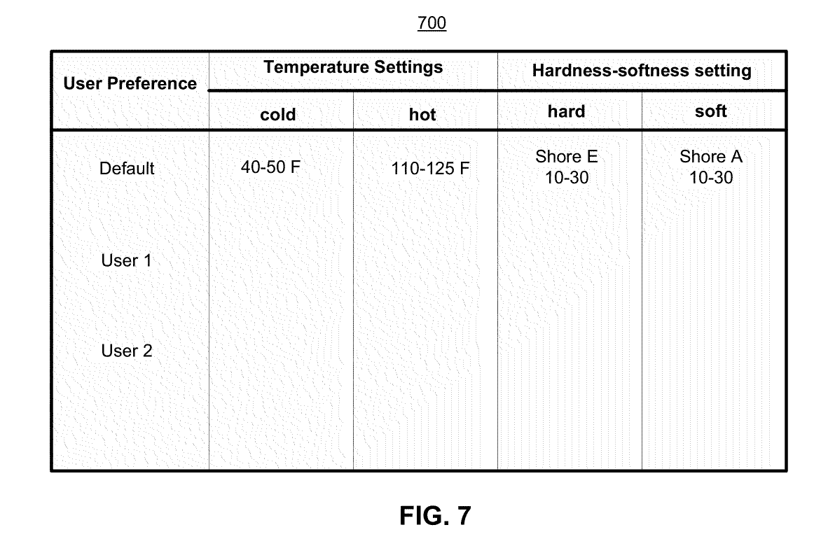

FIG. 7 illustrates a graphical user interface (UI) 700 to configure settings of temperature and/or hardness-softness sensations for one or more users, according to one embodiment of the invention. The UI 700 is represented as a table with default settings for temperature and/or hardness-softness ranges. Every user of the system 100 of FIG. 1A can customize the levels of temperature and hardness-softness sensations according to their personal comfort zones.

Some embodiments may be described as a process which is usually depicted as a flowchart, a flow diagram, a structure diagram, or a block diagram. Although a flowchart may describe the operations as a sequential process, many of the operations can be performed concurrently (i.e., in parallel). Likewise, operations in a flowchart illustrated as concurrent processes may be performed sequentially in some embodiments. In addition, the order of the operations may be re-arranged. A process is terminated when its operations are completed. A process may correspond to a method, a program, a procedure, a method of manufacturing or fabrication, etc.

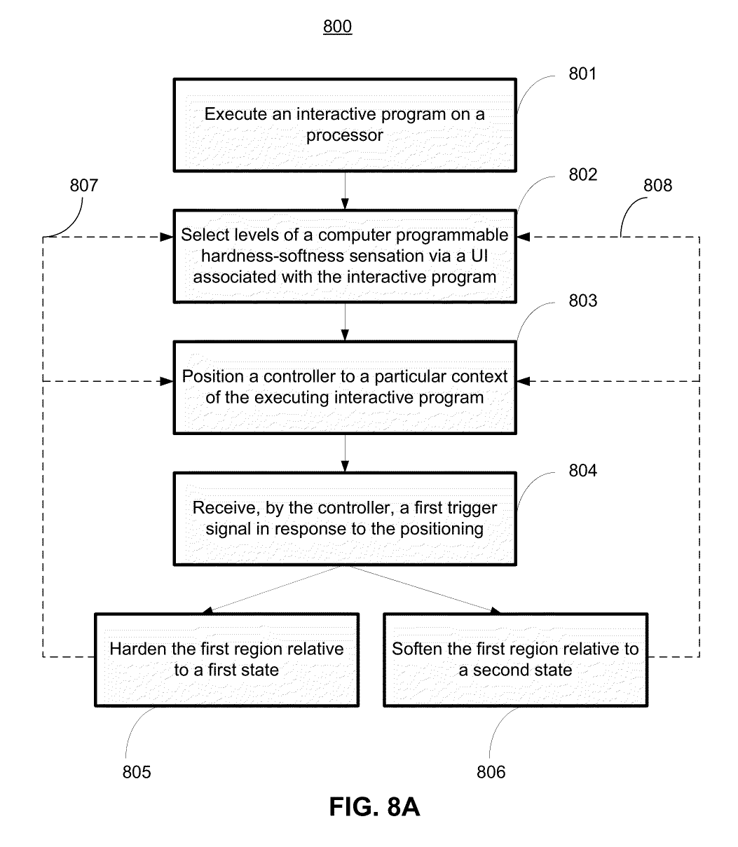

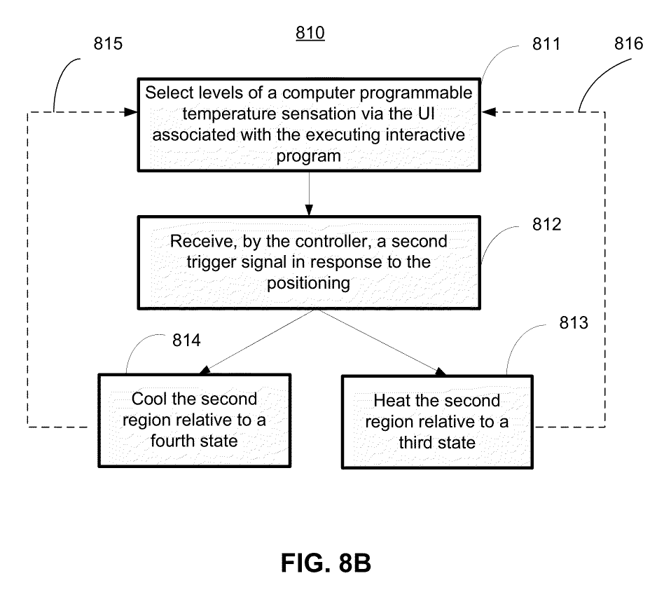

FIG. 8A is a high level method flowchart 800 for providing sensations of hardness-softness to a user, according to one embodiment of the invention. The flowcharts described herein are with reference to FIGS. 1-7. At block 801, an interactive program is executed on a processor of the computer system 102. At block 802, levels of hardness-softness sensations are selected via the UI 700 associated with the interactive program. At block 803, the controller 200 is positioned by a user to a particular context of the executing interactive program as shown by the exemplary contexts of FIG. 1B. At block 804, the controller 200 receives the first trigger signal from the computer system 102 in response to the positioning. The controller 200 then generates, in real-time, hardness-softness sensations to the user of the controller 200 via the first region 204 of the controller 200.

At block 805, the controller 200 causes the first region 204 to harden relative to the first state. In one embodiment, as shown by arrow 807, the user may adjust the level of hardness-softness sensation (e.g., select a new level of hardness-softness sensation in UI 700) in response to experiencing the hardness sensation at block 805. Arrow 807 also indicates that, in one embodiment, the user bypasses block 802, after experiencing the hardness sensation at block 805, and positions the controller 200 to a new context of the executing interactive program to receive another hardness sensation.

At block 806, the controller 200 causes the first region 204 to soften relative to the second state. In one embodiment, as shown by arrow 808, the user may adjust the level of hardness-softness sensation (e.g., select a new level on the hardness-softness sensation in UI 700) in response to experiencing the softness sensation. Arrow 808 also indicates that, in one embodiment, the user bypasses block 802, after experiencing the softness sensation, and positions the controller 200 to a new context of the executing interactive program to receive another softness sensation.

FIG. 8B is a high level method flowchart 810 for providing temperature sensations to a user, according to one embodiment of the invention. At block 811, a user selects levels of computer programmable temperature sensation via the UI 700 associated with the executing interactive program. At block 812, the controller 200 receives a second trigger signal in response to the positioning of the controller 200 towards a context of the executing interactive program. The controller 200 then provides the user in real-time computer programmable temperature sensation via the second region 205 of the controller 200 in response to the second trigger signal.

In one embodiment, at block 813 in response to the second trigger signal, the controller 200 causes the second region 205 to heat up by means of the heating source (part of 512) relative to a third state. In one embodiment, as shown by arrow 815, the user may adjust the level of temperature sensation (e.g., select a new heat level from the UI 700) in response to experiencing the heat sensation. In one embodiment, at block 814, the controller 200 causes the second region to cool down by means of the cooling source (part of 512) relative to a fourth state. In one embodiment, as shown by arrow 816, the user may adjust the level of temperature sensation (e.g., select a new coolness level from the UI 700) in response to experiencing the heat sensation.

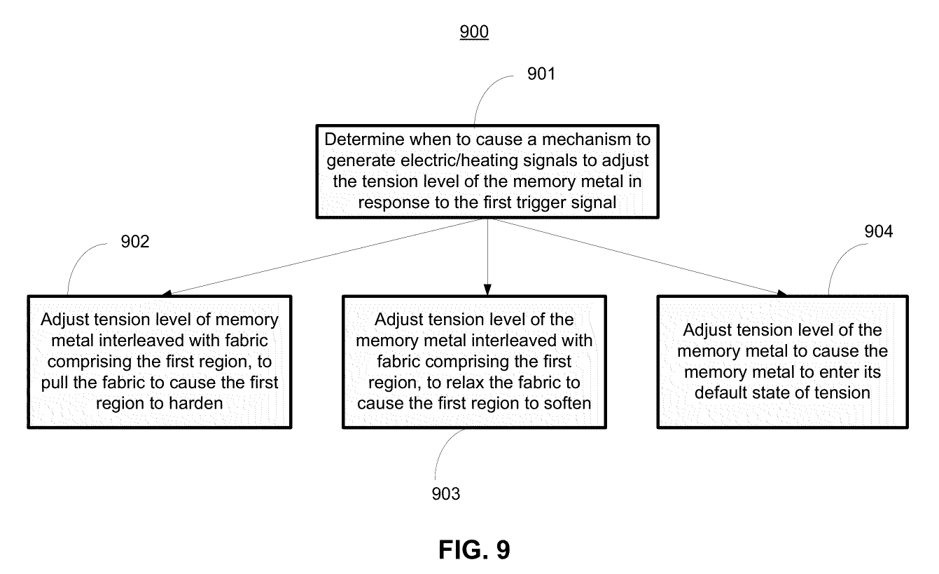

FIG. 9 is a method flowchart 900 for providing hardness-softness sensations to a user by means of a fabric 601/204 having interleaved memory metal 604, according to one embodiment of the invention. The method flowchart is described with respect to FIG. 6. At block 901, the logic unit 603 of the controller 200 determines when to cause the electronic signal generator 602 to generate the electric signal 605, in response to the first trigger signal, for adjusting tension levels of the interleaved memory metal 604. The tension levels in the memory metal 604 may be increased, decreased, or set to default levels by the electric signal 605 as shown by blocks 902, 903, and 904 respectively.

At block 902, in response to a first trigger signal, the electric signal 605 generated by the controller 200 causes the tension level of the memory metal 604 interleaved with the fabric 204/601 to increase. This increase in tension level causes the fabric 204/601 to stretch thus causing the fabric (first region) 204/601 to harden. At block 903, in response to the first trigger signal, the electric signal 605 causes the tension level of the memory metal 604 to decrease. This decrease in tension level causes the memory metal 604 to relax the fabric 204/601 and thus provide a sensation of softness. At block 904, the electric signal 605 (e.g., in response to turning on the system 100) causes the tension level of the memory metal 604 to enter its default state of tension.

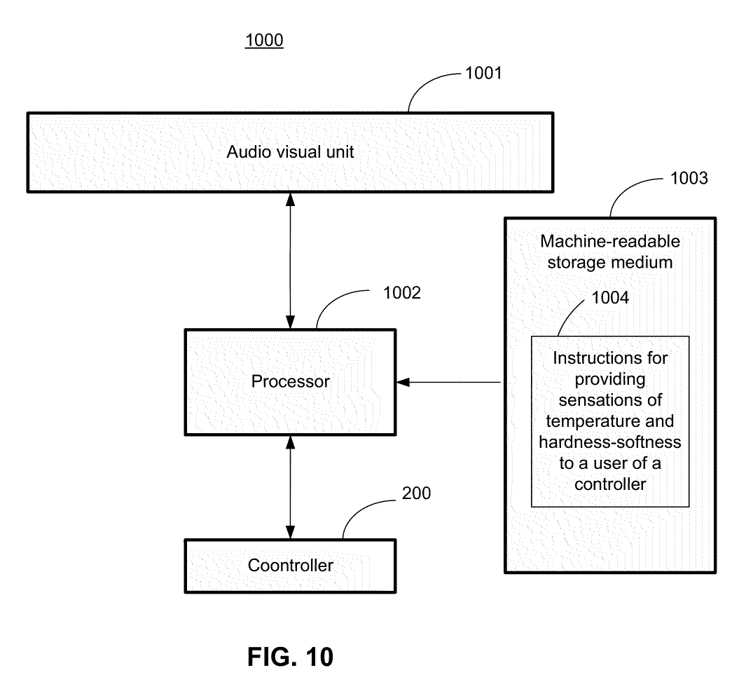

FIG. 10 is a high level interactive system diagram 1000 with a processor 1002 operable to execute computer readable instructions to cause sensations of temperature and hardness-softness to a user, according to one embodiment of the invention. Elements of embodiments are provided as a machine-readable medium 1003 for storing the computer-executable instructions. The computer readable/executable instructions codify the processes discussed in the embodiments of FIGS. 1-7 and the methods of FIGS. 8-9. In one embodiment, the processor 1002 communicates with an audio-visual device 1001 (same as 101 of FIG. 1A) to determine the first and second trigger signals.

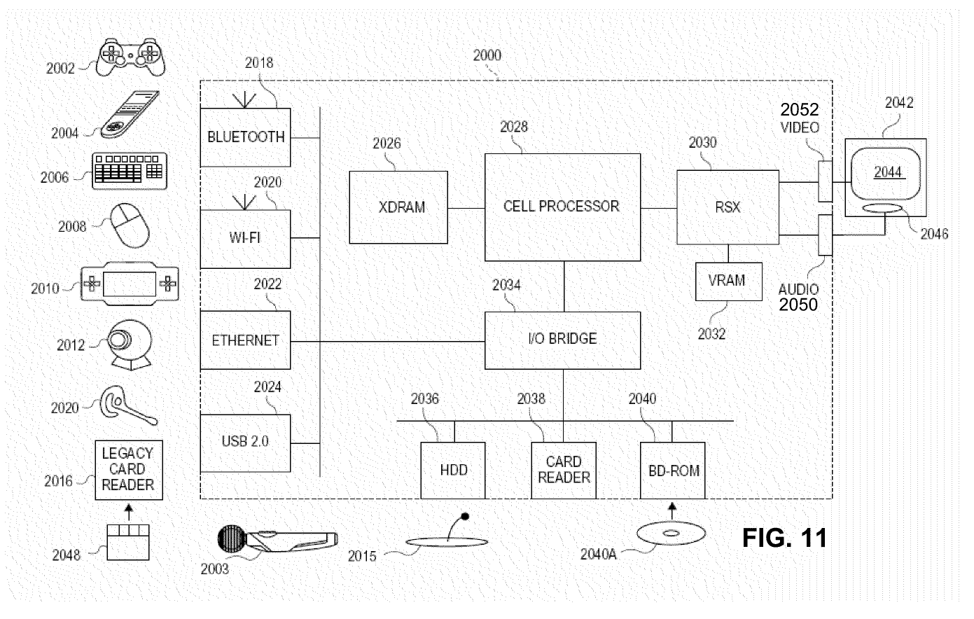

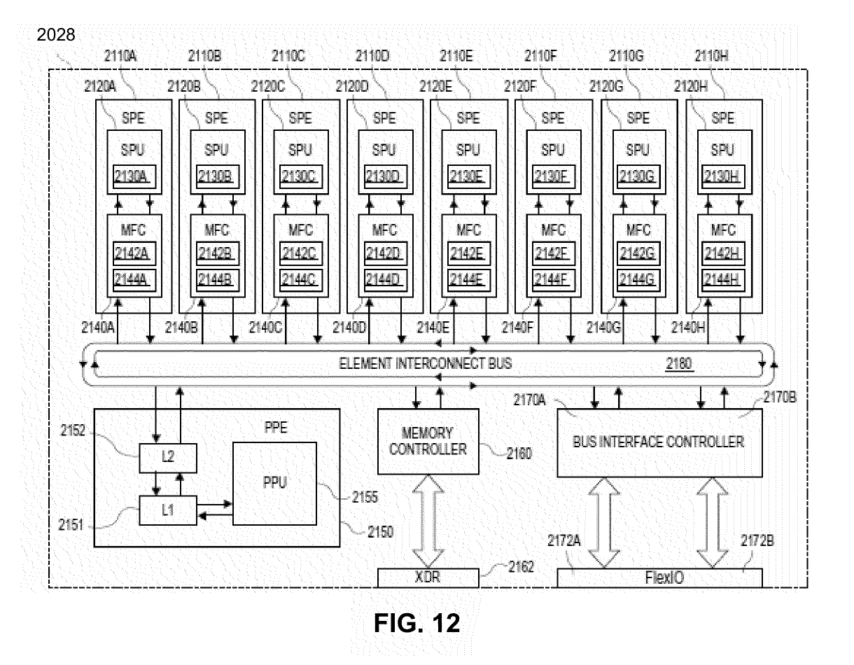

In one embodiment, the machine-readable medium 1003 may include, but is not limited to, flash memory, optical disks, CD-ROMs, DVD ROMs, RAMs, EPROMs, EEPROMs, magnetic or optical cards, or other type of machine-readable media suitable for storing electronic or computer-executable instructions. For example, embodiments of the invention may be downloaded as a computer program (e.g., BIOS) which may be transferred from a remote computer (e.g., a server) to a requesting computer (e.g., a client) by way of data signals via a communication link (e.g., a modem or network connection). The computer-executable instructions 1004 stored in the machine-readable medium 1003 are executed by a processor 1002 (discussed with reference to FIGS. 11-12). These computer-executable instructions 1004 when executed cause the controller 200 to provide sensations of temperature and hardness-softness in real-time in response to the first and second trigger signals associated with an interactive program which are executing on the same processor 1002 or a different processor.

FIG. 11 illustrates hardware of an interactive system with user interfaces which is operable to provide temperature and hardness-softness sensations, according to one embodiment of the invention. In one embodiment, FIG. 11 illustrates hardware and user interfaces that may be used to adapt a display based on object tracking, in accordance with one embodiment of the present invention. FIG. 11 schematically illustrates the overall system architecture of the Sony® Playstation® 3 entertainment device, a console that may be compatible for providing real-time sensations of temperature and hardness-softness to the controller 200, according to one embodiment of the invention.

In one embodiment, a platform unit 2000 is provided, with various peripheral devices connectable to the platform unit 2000. In one embodiment, the platform unit 2000 comprises: a Cell processor 2028; a Rambus® dynamic random access memory (XDRAM) unit 2026; a Reality Simulator graphics unit 2030 with a dedicated video random access memory (VRAM) unit 2032; and an I/O bridge 2034. In one embodiment, the platform unit 2000 also comprises a Blu Ray® Disk BD-ROM® optical disk reader 2040 for reading from a disk 2040A and a removable slot-in hard disk drive (HDD) 2036, accessible through the I/O bridge 2034. In one embodiment, the platform unit 2000 also comprises a memory card reader 2038 for reading compact flash memory cards, Memory Stick® memory cards and the like, which is similarly accessible through the I/O bridge 2034.

In one embodiment, the I/O bridge 2034 connects to multiple Universal Serial Bus (USB) 2.0 ports 2024; a gigabit Ethernet port 2022; an IEEE 802.11b/g wireless network (Wi-Fi) port 2020; and a Bluetooth® wireless link port 2018 capable of supporting of up to seven Bluetooth® connections.

In operation, the I/O bridge 2034 handles all wireless, USB and Ethernet data, including data from one or more game controllers 2003. For example when a user is playing a game, the I/O bridge 2034 receives data from the game (motion) controller 2003 (same as controller 200) via a Bluetooth® link and directs it to the Cell® processor 2028, which updates the current state of the game accordingly.

In one embodiment, the wireless USB and Ethernet ports also provide connectivity for other peripheral devices in addition to game controller 2003, such as: a remote control 2004; a keyboard 2006; a mouse 2008; a portable entertainment device 2010 such as a Sony Playstation® Portable entertainment device; a video image sensor such as an Playstation® Eye video image sensor 2012; a microphone headset 2020; a microphone array 2015, a card reader 2016, and a memory card 2048 for the card reader 2016. Such peripheral devices may therefore in principle be connected to the platform unit 2000 wirelessly; for example the portable entertainment device 2010 may communicate via a Wi-Fi ad-hoc connection, while the microphone headset 2020 may communicate via a Bluetooth link.

The provision of these interfaces means that the Sony Playstation 3® device is also potentially compatible with other peripheral devices such as digital video recorders (DVRs), set-top boxes, digital video image sensors, portable media players, Voice over IP telephones, mobile telephones, printers and scanners.

In one embodiment, the game controller 2002 is operable to communicate wirelessly with the platform unit 2000 via the Bluetooth® link, or to be connected to a USB port, thus also providing power by which to charge the battery of the game controller 2002. In one embodiment, the game controller 2002 also includes memory, a processor, a memory card reader, permanent memory such as flash memory, light emitters such as LEDs or infrared lights, microphone and speaker, a digital video image sensor, a sectored photodiode, an internal clock, and a recognizable/identifiable shape such as a spherical section facing the game console.

In one embodiment, the game controller 2002 is configured for three-dimensional location determination. Consequently gestures and movements by the user of the game controller 2002 may be translated as inputs to a game in addition to or instead of conventional button or joystick commands. Optionally, other wirelessly enabled peripheral devices such as the Playstation™ Portable device may be used as a controller. In the case of the Playstation™ Portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or the like.

In one embodiment, the remote control 2004 is also operable to communicate wirelessly with the platform unit 2000 via a Bluetooth link. The remote control 2004 comprises controls suitable for the operation of the Blu Ray™ Disk BD-ROM reader 2040 and for the navigation of disk content.

The Blu Ray™ Disk BD-ROM reader 2040 is operable to read CD-ROMs compatible with the Playstation® and PlayStation 2® devices, in addition to conventional pre-recorded and recordable CDs, and so-called Super Audio CDs. The reader 2040 is also operable to read DVD-ROMs compatible with the Playstation 2® and PlayStation 3® devices, in addition to conventional pre-recorded and recordable DVDs. The reader 2040 is further operable to read BD-ROMs compatible with the Playstation 3 device, as well as conventional pre-recorded and recordable Blu-Ray Disks.

The platform unit 2000 is operable to supply audio and video signals, either generated or decoded by the Playstation 3® device via the Reality Simulator graphics unit 2030, through audio 2050 and video connectors 2052 to an audio visual device 2042 such as the audio-visual device 101 of FIG. 1A. In one embodiment, the platform unit 2000 provides a video signal, via the video connector 2052, to a display 2044 of the audio visual device 2042. In one embodiment, the audio connector 2050 provides an audio signal to a sound output device 2046 of the audio visual device 2042. The audio connectors 2050 may include conventional analog and digital outputs while the video connectors 2052 may variously include component video, S-video, composite video and one or more High Definition Multimedia Interface (HDMI) outputs. Consequently, video output may be in formats such as PAL or NTSC, or in 720p, 1080i or 1080p high definition.

In one embodiment, the video image sensor 2012 comprises a single charge coupled device (CCD) and a LED indicator. In some embodiments, the video image sensor 2012 includes software and hardware-based real-time data compression and encoding apparatus so that compressed video data may be transmitted in an appropriate format such as an intra-image based MPEG (motion picture expert group) standard for decoding by the platform unit 2000. In one embodiment, the video image sensor LED indicator is arranged to illuminate in response to appropriate control data from the platform unit 2000, for example, to signify adverse lighting conditions.

Embodiments of the video image sensor 2012 may variously connect to the platform unit 2000 via an HDMI, USB, Bluetooth® or Wi-Fi communication port. Embodiments of the video image sensor may include one or more associated microphones and may also be capable of transmitting audio data. In embodiments of the video image sensor, the CCD may have a resolution suitable for high-definition video capture. In one embodiment, the images captured by the video image sensor is incorporated within a game or interpreted as game control inputs. In another embodiment the video image sensor is an infrared video image sensor suitable for detecting infrared light.

FIG. 12 illustrates additional hardware which is operable to process computer executable instructions to cause the interactive system to provide temperature and hardness-softness sensations, according to one embodiment of the invention. In one embodiment, the Cell® processor 2028 of FIG. 11, as further illustrated in FIG. 12, comprises four basic components: external input and output structures comprising a memory controller 2160 and a dual bus interface controller 2170A, B; a main processor referred to as the Power Processing Element 2150; eight co-processors referred to as Synergistic Processing Elements (SPEs) 2110A-H; and a circular data bus connecting the above components referred to as the Element Interconnect Bus 2180.

In one embodiment, the Power Processing Element (PPE) 2150 is based upon a two-way simultaneous multithreading Power 2070 compliant PowerPC core (PPU) 2155 running with an internal clock of 3.2 GHz. It comprises a 512 kB level 2 (L2) cache 2152 and a 32 kB level 1 (L1) cache 2151. The PPE 2150 is capable of eight single position operations per clock cycle, translating to 25.6 GFLOPs at 3.2 GHz. The primary role of the PPE 2150 is to act as a controller for the SPEs 2110A-H, which handle most of the computational workload. In operation the PPE 2150 maintains a job queue, scheduling jobs for the SPEs 2110A-H and monitoring their progress. Consequently each SPE 2110A-H runs a kernel whose role is to fetch a job, execute it and synchronize it with the PPE 2150.

In one embodiment, each Synergistic Processing Element (SPE) 2110A-H comprises a respective Synergistic Processing Unit (SPU) 2120A-H, and a respective Memory Flow Controller (MFC) 2140A-H comprising in turn a respective Dynamic Memory Access Controller (DMAC) 2142A-H, a respective Memory Management Unit (MMU) 2144A-H and a bus interface (not shown). In one embodiment, each SPU 2120A-H is a RISC processor having local RAM 2130A-H.

In one embodiment, the Element Interconnect Bus (EIB) 2180 is a logically circular communication bus internal to the Cell processor 2028 which connects the above processor elements, namely the PPE 2150, the memory controller 2160, the dual bus interface controller 2170A, B and the 8 SPEs 2110A-H, totaling 12 participants. Participants can simultaneously read and write to the bus at a rate of at least 8 bytes per clock cycle. As noted previously, each SPE 2110A-H comprises a DMAC 2142A-H for scheduling longer read or write sequences. The EIB 2180 comprises four channels, two each in clockwise and anti-clockwise directions. Consequently for twelve participants, the longest step-wise data-flow between any two participants is six steps in the appropriate direction.

In one embodiment, the memory controller 2160 comprises an XDRAM interface 2162 through which the memory controller 2160 interfaces with XDRAM. The dual bus interface controller 2170A, B comprises a system interface 2172A, B.

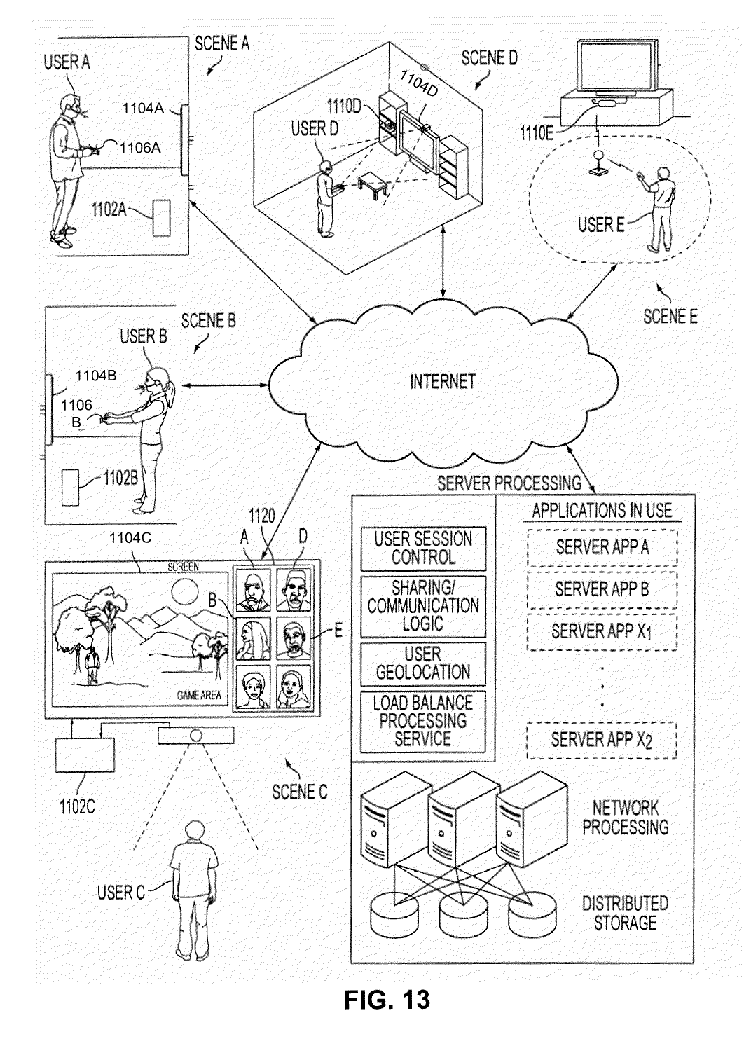

FIG. 13 illustrates an interactive system with users interactive with one another via the internet, according to one embodiment of the invention. FIG. 13 is an exemplary illustration of scene A through scene E with respective user A through user E interacting with game clients 1102 that are connected to server processing via the internet, in accordance with one embodiment of the present invention. A game client is a device that allows users to connect to server applications and processing via the internet. The game client allows users to access and playback online entertainment content such as but not limited to games, movies, music and photos. Additionally, the game client can provide access to online communications applications such as VOIP, text chat protocols, and email.

A user interacts with the game client via the controller 200 of FIG. 2. In some embodiments the controller 200 is a game client specific controller while in other embodiments, the controller 200 can be a keyboard and mouse combination. In one embodiment, the game client is a standalone device capable of outputting audio and video signals to create a multimedia environment through a monitor/television and associated audio equipment. For example, the game client can be, but is not limited to a thin client, an internal PCI-express card, an external PCI-express device, an ExpressCard device, an internal, external, or wireless USB device, or a Firewire device, etc. In other embodiments, the game client is integrated with a television or other multimedia device such as a DVR, Blu-Ray player, DVD player or multi-channel receiver.

Within scene A of FIG. 13, user A interacts with a client application displayed on a monitor 1104A using a controller 1106A (same as controller 200) paired with game client 1102A. Similarly, within scene B, user B interacts with another client application that is displayed on monitor 1104B using a controller 1106B paired with game client 1102B. Scene C illustrates a view from behind user C as he looks at a monitor displaying a game and buddy list from the game client 1102C. While FIG. 13 shows a single server processing module, in one embodiment, there are multiple server processing modules throughout the world. Each server processing module includes sub-modules for user session control, sharing/communication logic, user geo-location, and load balance processing service. Furthermore, a server processing module includes network processing and distributed storage.

When a game client(s) 1102A-C connects to a server processing module, user session control may be used to authenticate the user. An authenticated user can have associated virtualized distributed storage and virtualized network processing. Examples of items that can be stored as part of a user's virtualized distributed storage include purchased media such as, but not limited to games, videos and music etc. Additionally, distributed storage can be used to save game status for multiple games, customized settings for individual games, and general settings for the game client. In one embodiment, the user geo-location module of the server processing is used to determine the geographic location of a user and their respective game client. The user's geographic location can be used by both the sharing/communication logic and the load balance processing service to optimize performance based on geographic location and processing demands of multiple server processing modules. Virtualizing either or both network processing and network storage would allow processing tasks from game clients to be dynamically shifted to underutilized server processing module(s). Thus, load balancing can be used to minimize latency associated with both recall from storage and with data transmission between server processing modules and game clients.

The server processing module has instances of server application A and server application B. The server processing module is able to support multiple server applications as indicated by server application X₁ and server application X₂. In one embodiment, server processing is based on cluster computing architecture that allows multiple processors within a cluster to process server applications. In another embodiment, a different type of multi-computer processing scheme is applied to process the server applications. This allows the server processing to be scaled in order to accommodate a larger number of game clients executing multiple client applications and corresponding server applications. Alternatively, server processing can be scaled to accommodate increased computing demands necessitated by more demanding graphics processing or game, video compression, or application complexity. In one embodiment, the server processing module performs the majority of the processing via the server application. This allows relatively expensive components such as graphics processors, RAM, and general processors to be centrally located and reduces the cost of the game client. Processed server application data is sent back to the corresponding game client via the internet to be displayed on a monitor.

Scene C illustrates an exemplary application that can be executed by the game client and server processing module. For example, in one embodiment game client 1102C allows user C to create and view a buddy list 1120 that includes user A, user B, user D and user E. As shown, in scene C, user C is able to see either real time images or avatars of the respective user on monitor 1104C. Server processing executes the respective applications of game client 1102C and with the respective game clients 1102 of user A, user B, user D and user E. Because the server processing is aware of the applications being executed by game client B, the buddy list for user A can indicate which game user B is playing. Further still, in one embodiment, user A can view actual in-game video directly from user B. This is enabled by merely sending processed server application data for user B to game client A in addition to game client B.

In addition to being able to view video from buddies, the communication application can allow real-time communications between buddies. As applied to the previous example, this allows user A to provide encouragement or hints while watching the real-time video of user B. In one embodiment two-way real time voice communication is established through a client/server application. In another embodiment, a client/server application enables text chat. In still another embodiment, a client/server application converts speech to text for display on a buddy's screen.

Scene D and scene E illustrate respective user D and user E interacting with game consoles 1110D and 1110E respectively. Each game console 1110D and 1110E are connected to the server processing module and illustrate a network where the server processing modules coordinate game play for both game consoles and game clients. According to the embodiments of the invention, each user will receive real-time sensations of temperature and hardness-softness by means of their respective controllers which are configured to receive the first and second trigger signals from the interactive program based on the context of interactive program.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

While the invention has been described in conjunction with specific embodiments thereof, many alternatives, modifications and variations of such embodiments will be apparent to those of ordinary skill in the art in light of the foregoing description. For example, with reference to FIG. 5B, temperature sensations can also be provided by electric coils located in the region 514. Likewise, acoustic refrigerating technologies may also be used in the region 514. The embodiments of the invention are intended to embrace all such alternatives, modifications, and variations as to fall within the broad scope of the appended claims.

We claim:

1. A hand-held controller comprising:
a first region configured to be touched by a user and to provide a real-time computer programmable hardness-softness sensation to the user in response to a first trigger signal generated by an interactive program; and
a first mechanism, coupled to the first region, to cause the first region to harden relative to a first state, and to cause the first region to soften relative to a second state.

2. The hand-held controller of claim 1 further comprising:
a second region configured to be touched by the user and to provide real-time computer programmable temperature sensation to the user in response to a second trigger signal generated by the interactive program;
a second mechanism, coupled to the second region, to cause the second region to heat up relative to a third state and to cause the second region to cool down relative to a fourth state.

3. The hand-held controller of claim 2, wherein the first and second regions are adjacent to one another.

4. The hand-held controller of claim 2 further comprises interactive buttons having the first and second regions on the surface of the interactive buttons.

5. The hand-held controller of claim 2, wherein the second mechanism comprises:
a thermal controller for determining when to activate a heating source to heat the second region and when to activate a cooling source to cool the second region, in response to the second trigger signal.

6. The hand-held controller of claim 2, wherein levels of the real-time computer programmable hardness-softness and temperature sensations are programmed by selecting levels of the respective sensations via a user interface associated with the interactive program, and wherein the first and second trigger signals are generated in real-time by the interactive program when a position of the hand-held controller corresponds to a particular context of the interactive program.

7. The hand-held controller of claim 1, wherein the first region comprises a fabric, and wherein the first mechanism comprises:
a push-pull mechanism which is operable to:
pull the fabric to cause the fabric to harden relative to the first state, and
relax the fabric to cause the fabric to soften relative to the second state; and
an electric motor to cause the push-pull mechanism to pull or relax the fabric.

8. The hand-held controller of claim 1, wherein the first region comprises a fabric having interleaved memory metal which is operable to:
stretch the fabric causing the fabric to harden relative to the first state; and
relax the fabric causing the fabric to soften relative to the second state, and wherein the first mechanism further comprises an electronic signal generator to adjust a tension level of the interleaved memory metal to cause the interleaved memory metal to stretch or relax the fabric.

9. The hand-held controller of claim 2, wherein the interactive program is a game or an audio-visual program, wherein the first and second states represent levels of hardness-softness of the first region, and wherein the third and fourth states represent temperature of the second region.

10. The hand-held controller of claim 1, wherein the first mechanism comprises:
a reservoir to store an inflating material;
a cavity coupled to the first region; and
a pump to:
pump out the inflating material from the reservoir to the cavity to inflate the cavity to cause a sensation of hardness, and
suck the inflating material from the cavity to the reservoir to deflate the cavity to cause a sensation of softness.

11. The hand-held controller of claim 1, wherein the first mechanism comprises:
a cooling source to cause a material in the first region to harden relative to the first state;
a heating source to cause the material in the first region to soften relative to the second state; and
a logic unit for determining when to activate the cooling and heating sources in response to the first trigger signal.

12. A system comprising:
a processor;
an interactive application executing on the processor, the interactive application to generate a first trigger signal representing a context of the executing interactive program; and
a hand-held controller comprising:
a first region configured to be touched by a user and to provide a real-time computer programmable hardness-softness sensation to the user in response to the first trigger signal generated by the interactive program; and
a first mechanism, coupled to the first region, to cause the first region to harden relative to a first state, and to cause the first region to soften relative to a second state.

13. The system of claim 12, wherein the hand-held controller further comprises:
a second region configured to be touched by the user and to provide real-time computer programmable temperature sensation to the user in response to a second trigger signal generated by the interactive program; and
a second mechanism, coupled to the second region, to cause the second region to heat up relative to a third state and to cause the second region to cool down relative to a fourth state.

14. The system of claim 13, wherein the second mechanism comprises:
a thermal controller for determining when to activate a heating source to heat the second region and when to activate a cooling source to cool the second region, in response to the second trigger signal.

15. The system of claim 13, wherein the hand-held controller comprises buttons to interact with the executing interactive program, wherein the interactive program is a game or an audio-visual program, wherein the first and second states represent levels of hardness-softness of the first region, wherein the third and fourth states represent temperature of the second region, and wherein the first and second trigger signals are generated in real-time by the interactive program when a position of the hand-held controller corresponds to a particular context of the interactive program.

16. The system of claim 12, wherein the first region comprises a fabric, and wherein the first mechanism comprises:
a push-pull mechanism which is operable to:
pull the fabric to cause the fabric to harden relative to the first state, and
relax the fabric to cause the fabric to soften relative to the second state;
an electric motor to cause the push-pull mechanism to pull or relax the fabric; and
a logic unit which is operable to receive the first trigger signal and to determine when to cause the push-pull mechanism to pull or relax the fabric in response to the first trigger signal.

17. The system of claim 12, wherein the first region comprises a fabric having interleaved memory metal which is operable to:
stretch the fabric causing the fabric to harden relative to the first state, and
relax the fabric causing the fabric to soften relative to the second state, and, and wherein the first mechanism further comprises an electronic signal generator to adjust a tension level of the interleaved memory metal to cause the interleaved memory metal to stretch or relax the fabric.

18. The system of claim 12, wherein the first mechanism comprises:
a reservoir to store an inflating material;
a cavity coupled to the first region;
a pump to:
pump out the inflating material from the reservoir to the cavity to inflate the cavity to cause a sensation of hardness, and
suck the inflating material from the cavity to the reservoir to deflate the cavity to cause a sensation of softness; and
a logic unit which is operable to receive the first trigger signal and to determine when to cause the pump to pump out or suck the inflating material in response to the first trigger signal.

19. A method comprising:
executing an interactive program on a processor;
selecting levels of a computer programmable hardness-softness sensation via a user interface associated with the executing interactive program;
positioning a controller to a particular context of the interactive program;
receiving, by the controller, a first trigger signal in response to the positioning; and
in response to receiving the first trigger signal, performing one of:
generating a first signal to cause a first region of the controller to harden relative to a first state; and
generating a second signal to cause the first region of the controller to soften relative to a second state.

20. The method of claim 19, wherein the first region comprises a fabric with interleaved memory metal, and wherein the method further comprises:
adjusting a tension level of the interleaved memory metal to pull the fabric causing the fabric to harden relative to the first state;
adjusting the tension level of the interleaved memory metal to relax the fabric causing the fabric to soften relative to the second state; and
adjusting the tension level of the interleaved memory metal to enter its default state of tension,
wherein the interactive program is a game or an audio-visual program, wherein the first and second states represent levels of hardness-softness of the first region.
